(19) United States
(12) Patent Application Publication
(10) Pub. No.: US 2020/0062303 A1
(43) Pub. Date: Feb. 27, 2020

(54) WHEEL SUSPENSION DEVICE HAVING SINGLE-WHEEL STEERING FOR A MOTOR VEHICLE WITH DRIVING OF THE STEERED WHEELS

(71) Applicants: THYSSENKRUPP PRESTA AG, Eschen (LI); thyssenkrupp AG, Essen (DE)

(72) Inventors: Josef ALTHAUS, Fischen (DE); Kristian MURKOVIC, Sargans (CH); Björn-bruce MARTIN, St. Gallen (CH)

(73) Assignees: THYSSENKRUPP PRESTA AG, Eschen (LI); thyssenkrupp AG, Essen (DE)

(21) Appl. No.: 16/346,437

(22) PCT Filed: Nov. 14, 2017
(86) PCT No.: PCT/EP2017/079118

§ 371 Date: Apr. 30, 2019

(30) Foreign Application Priority Data
Nov. 15, 2016 (DE) 10 2016 222 434.4

(51) Int. Cl. B62D 7/06; B62D 5/00; B62D 3/04

(52) U.S. Cl. CPC B62D 7/06; B62D 3/04; B62D 5/006

(57) ABSTRACT

A wheel suspension device having a single-wheel steering for a motor vehicle with driving of the steered wheels, having a steering knuckle spring-suspended on the vehicle chassis for rotatably supporting a vehicle wheel. The steering knuckle can be pivoted about a pivot axis by means of the single-wheel steering. The single-wheel steering includes a worm gear having a worm wheel, which is rotationally fixed to the steering knuckle and arranged coaxially with the pivot axis, and which meshes with a worm, by means of which the worm wheel can be rotated about the pivot axis and which can be driven by a steering motor arranged on the vehicle chassis by way of a steering drive shaft in the form of an articulated shaft.

The invention relates to a wheel suspension device having single-wheel steering for a motor vehicle with driving of the steered wheels, having a steering knuckle spring-suspended on the vehicle chassis for rotatably supporting a vehicle wheel, wherein the steering knuckle can be pivoted about a pivot axis by means of the single-wheel steering.

In single-wheel steering systems, which are also known as steer-by-wire steering systems, the steerable wheels of the motor vehicle can be swiveled independently of one another. Here a steering command delivered by the driver by way of the steering wheel is detected by means of a sensor and then relayed to an electronic control unit (ECU), which activates control motors of the single-wheel steering as a function of the steering-wheel torque and the steering angle and thereby swivels the steerable wheels according to the driver's wishes.

DE 10 2008 039 547 A1 discloses a single-wheel steering which is of a complicated and bulky construction, however. A drive shaft serving to drive the steered wheel takes the form of an articulated shaft and is connected to the steerable wheel by way of a constant-velocity joint. The maximum steering angle is thereby limited to approximately 40°.

KR 10 2011 005 286 0 likewise discloses a single-wheel steering in which the steered wheels can be swiveled by means of linear drives and by way of complex steering elements with steering tie rods. The control by means of linear drives is complex. This known single-wheel steering, too, only allows steering angles of approximately 40°.

The object of the invention is to provide a single-wheel steering of the aforesaid type which is of simple and compact construction and allows large steering angles.

The object is achieved by the features of patent claim 1; advantageous developments emerge from the dependent claims.

In the solution according to the invention the single-wheel steering comprises a worm gear having a worm wheel, which is rotationally fixed to the steering knuckle and arranged coaxially with the pivot axis, and which meshes with a worm, by means of which the worm wheel can be rotated about the pivot axis and which can be driven by a steering motor arranged on the vehicle chassis by way of a steering drive shaft in the form of an articulated shaft. The worm gear according to the invention has the advantage that the worm wheel can be rotated over a substantially larger angular range, which affords larger steer angles of the steered vehicle wheel than swiveling by means of a tie rod. Here the steering motor is arranged on the vehicle chassis and therefore makes no contribution to the unsprung mass on the vehicle wheel. In order to allow compression of the steered wheel, a steering drive shaft in the form of an articulated shaft is provided between the worm and the steering motor. The steering motor is preferably an electric motor, since this is particularly easy to control by means of a control unit (ECU). It is also possible to use another type of motor, however, for example a hydraulic motor.

In an advantageous embodiment the worm wheel takes the form of a worm wheel segment. In an advantageous development the worm wheel in the form of a worm wheel segment extends over a circumferential range between 180° and 270°, more preferably between 190° and 200°. From its neutral position in straight-line driving of the motor vehicle the steered vehicle wheel can preferably be swiveled by −70° to +90°. This embodiment ensures a large swiveling range of the steered vehicle wheel for a reduced weight of the worm wheel contributing to the unsprung mass, and takes up less overall space, since parts of the worm wheel not needed for swiveling of the steered wheel have been eliminated.

In a further advantageous embodiment of the invention the steered vehicle wheel is coupled to a drive, wherein the drive is provided by means of a wheel drive shaft in the form of an articulated shaft, wherein a double bevel gear train is operatively arranged between the wheel drive shaft and a driven wheel axle shaft of the vehicle wheel. In this embodiment the wheel drive shaft in the form of an articulated shaft serves solely to compensate for the compression movement of the steered vehicle wheel, whilst the swiveling movement is afforded by the double bevel gear train, which is not subject to the limitations of an articulated shaft in terms of the maximum steering angle. Even at large steering angles of −70° to +90°, drive torques can be transmitted to the driven vehicle wheel via the double bevel gear train.

In a further advantageous embodiment of the invention the double bevel gear train comprises two bevel gears rotationally fixed to one other and rotatably supported on the steering knuckle coaxially with the pivot axis, of which an upper bevel gear meshes with an inner bevel gear rotationally fixed to the wheel drive shaft, and a lower bevel gear meshes with an outer bevel gear rotationally fixed to the driven wheel axle shaft, so that a drive torque can be transmitted from the wheel drive shaft via the inner bevel gear to the upper bevel gear and from this to the lower bevel gear and from the latter to the outer bevel gear and the wheel axle shaft. This embodiment of the bevel gear train is of compact and simple design.

In order to fix and rotatably support said components in the correct position relative to one another, it is proposed that the bevel gear train and the worm are arranged in a housing, which is connected to the steering knuckle and which is not capable of pivoting relative to the pivot axis but is spring-suspended with the steering knuckle in the direction of the pivot axis. The housing with the worm can thereby follow the compression movement and the worm is able to generate a torque on the worm wheel.

To complete the sprung suspension of the steered and driven vehicle wheel it is recommended that the housing on its underside be articulated on the vehicle chassis by means of a transverse link.

An exemplary embodiment of the invention is explained in more detail below, referring to the drawings. The figures show in detail:

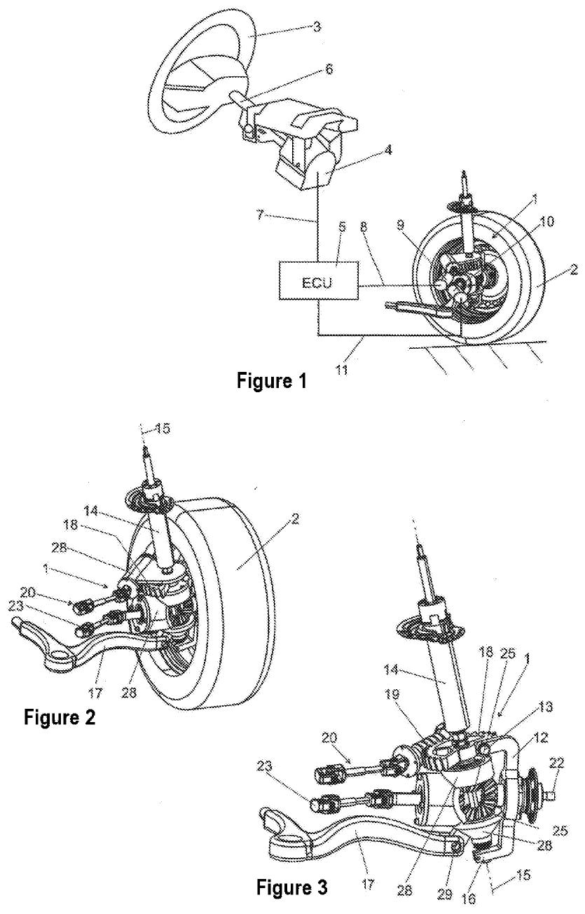

FIG. 1: a sketch showing the principle of a single-wheel steering with a wheel suspension device according to the invention in a perspective representation;

FIG. 2: a perspective representation of a wheel suspension device according to the invention with vehicle wheel;

FIG. 3: the wheel suspension device in FIG. 2 without the vehicle wheel;

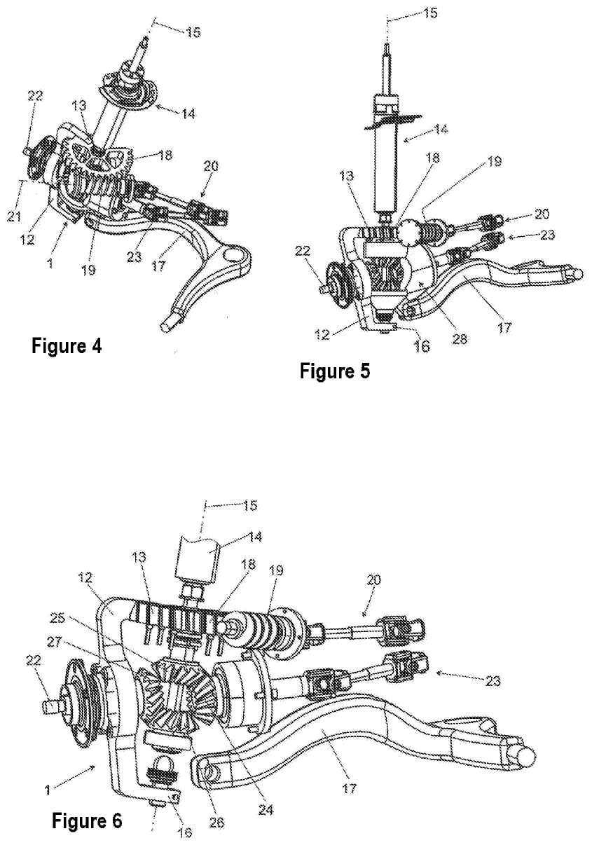

FIG. 4: the wheel suspension device according to the invention in FIG. 3 without housing parts in order to illustrate its working;

FIG. 5: a wheel suspension device according to FIG. 3, but viewed from a different angle;

FIG. 6: a wheel suspension device according to FIG. 4, but viewed from a different angle.

FIG. 1 shows a steer-by-wire steering system for the single-wheel steering of a steered and driven vehicle wheel 2, which is fixed to the vehicle chassis (not shown) by means of a wheel suspension device 1 according to the invention. The driver's steering command is mechanically transmitted to a sensor unit 4 via a steering wheel 4 and an articulated shaft 6. The sensor unit 4 detects the steering angle predetermined by the driver and the steering-wheel torque and from these generates control signals, which are relayed via a signal line 7 to an electronic control unit (ECU) 5. By way of an electrical control line 8 the electronic control unit 5 activates a steering motor 9 in the form of an electric motor, which swivels the vehicle wheel 2 according to the demands of the driver. A steering-wheel torque sensor 10 of the wheel suspension device 1 determines the actual steering-wheel torque occurring on the vehicle wheel 2 and via an electrical signal line 11 sends a correspondingly coded signal to the control unit 5, which in turn via the sensor unit 4 generates a steering counter-torque on the articulated shaft 6 and the steering wheel 3, in order to give the driver a realistic steering feel and thereby some feedback on the instantaneous driving situation.

FIGS. 2 to 6 show the wheel suspension device 1 according to the invention from various perspectives. A steering knuckle 12 is connected on its upper side 13 to a suspension strut 14 in the form of a MacPherson suspension strut, which is in turn is fixed to the vehicle chassis (not shown). The suspension strut 14 is arranged tilted from the vertical and defines a pivot axis 15, about which the steering knuckle 12 and the vehicle wheel 2 are capable of pivoting. In addition, the suspension strut 14 allows compression of the steering knuckle 12 and of the vehicle wheel 2 in the direction of the pivot axis 15. In the area of its underside 16, either the steering knuckle 12 itself or a housing 28 connected to the steering knuckle 12 is connected to a transverse link 17, by which the steering knuckle 12 or the housing 28 is articulated on the vehicle chassis (not shown).

It is likewise feasible and possible to use a double wishbone wheel suspension as an alternative to a MacPherson suspension strut.

Forming part of the single-wheel steering is a worm gear comprising a worm wheel 18 and a worm 19. The worm wheel axis of the worm wheel 18 coincides with the pivot axis 15. The worm wheel 18 is furthermore rotationally fixed to the steering knuckle 12, so that a rotation of the worm wheel 18 gives rise to a corresponding swiveling of the steering knuckle 12 and the vehicle wheel 2.

The worm wheel 18 takes the form of a worm wheel segment. As can best be seen from FIG. 4, the worm wheel 18 extends over a circumferential range of somewhat more than 180°. The worm wheel portions falling outside this circumferential range have been omitted in order to save weight and overall space.

Meshing with the worm wheel 18 is a worm 19, which in turn is connected by a steering drive shaft 20 in the form of an articulated shaft to an electric motor 9 arranged on the vehicle chassis (not shown). The electric motor 9 serves for rotating the steering drive shaft 20 and thereby the worm 19 about its worm axis 21. The rotating worm 19 turns the worm wheel 18 about the pivot axis 15, and the steering knuckle 12 and the vehicle wheel 2 mounted on the steering knuckle are thereby swiveled about the pivot axis 15. Only a wheel axle shaft 22 of the vehicle wheel 2 is visible in FIGS. 3 to 6.

With the given design of the worm wheel 18, the vehicle wheel 2 can therefore be swiveled about a steering angle from −70° to +90° from its neutral position in straight-line driving of the motor vehicle. This swiveling range is significantly larger than the maximum swiveling range of steering devices that use tie rods.

In order to generate a steering-wheel torque by rotating the worm 19 on the worm wheel 18, it is necessary to brace the counter-torque occurring on the worm 19. The worm 19 is thereby not swiveled about the pivot axis 15 together with the worm wheel 18, but remains in a fixed position relative to the pivot axis 15.

The steered vehicle wheel 2 is driven by means of a wheel drive shaft 23, which is driven by the vehicle engine (not shown) via a transmission (not shown) and which takes the form of an articulated shaft, in order to compensate for the spring travel occurring during the compression of the vehicle wheel 2 and the steering knuckle 12 in the direction of the pivot axis 15. In order to allow a large swiveling range of the vehicle wheel 2 about the pivot axis 15, a double bevel gear train 24, 25, 26, 27, which serves for transmitting a drive torque, is operatively arranged between the wheel drive shaft 23 and the driven wheel axle shaft 22.

The double bevel gear train comprises an upper bevel gear 25 and a lower bevel gear 26, which are rotationally fixed to one other but are rotatably supported on the steering knuckle 12. The wheel drive shaft 23 is connected to an inner bevel gear 24, which meshes with the upper bevel gear 25. The driven wheel axle shaft 22 is connected to an outer bevel gear 27, which meshes with the lower bevel gear 26. The drive torque is therefore transmitted via the wheel drive shaft 23 to the inner bevel gear 24 and from this to the upper bevel gear 25, which is rotationally fixed to the lower bevel gear 26 and thereby transmits the drive torque via the lower bevel gear 26 to the outer bevel gear 27, which is rotationally fixed to the wheel axle shaft 22, so that the drive torque is ultimately transmitted to the vehicle wheel 2.

Arranging the upper bevel gear 25 and the lower bevel gear 26 coaxially with the pivot axis 15 allows the steering knuckle 12 to be swiveled in a wide swiveling range about the pivot axis 15, wherein the outer bevel gear 27 rolls on the lower bevel gear 26 and comes closer to the inner bevel gear 24. In this way swivel angles of up to 90° are possible in each direction, wherein a drive torque can still be transmitted from the wheel drive shaft 23 to the wheel axle shaft 22 via the double bevel gear train 24, 25, 26, 27 even at such extreme swivel angles.

In order to fix the bevel gears 24 to 27 of the bevel gear train in their correct position relative to one another, a housing 28 is provided, which supports the bevel gears 24 to 27 and the worm 19 and which cannot be rotated together with the steering knuckle 12. The housing 28 also absorbs the torque occurring on the worm 19. The steering knuckle 12 is capable of swiveling in relation to the housing 28 about the pivot axis 15. On the other hand, the housing 28 moves together with the steering knuckle 12 under the compression of the vehicle wheel 2 in the direction of the pivot axis 15 and thereby contributes to the unsprung mass. The transverse link 17 is articulated on the underside of the housing 28. The pivot point 29 can be seen in FIG. 3.

The invention therefore creates a wheel suspension device 1 for a driven and steered vehicle wheel 2, which is of very compact and simple construction and allows a very large swiveling range of the vehicle wheel 2 from −70° to +90° relative to the neutral position in straight-line driving of the motor vehicle.

### LIST OF REFERENCE NUMERALS

1 wheel suspension device
2 vehicle wheel
3 steering wheel
4 sensor unit
5 control unit ECU
6 steering shaft
7 signal line
8 control line
9 steering motor
10 steering-wheel torque sensor
11 signal line
12 steering knuckle
13 upper side
14 suspension strut
15 pivot axis
16 underside
17 transverse link
18 worm wheel
19 worm
20 steering drive shaft
21 worm axis
22 wheel axle shaft
23 wheel drive shaft
24 inner bevel gear
25 upper bevel gear
26 lower bevel gear
27 outer bevel gear
28 housing
29 pivot point

1.-7. (canceled)

8. A wheel suspension device having single-wheel steering for a motor vehicle with driving of the steered wheels, comprising:
a steering knuckle spring-suspended on the vehicle chassis, the steering knuckle configured to rotatably support a vehicle wheel,
wherein the steering knuckle is configured to pivot about a pivot axis by means of the single-wheel steering,
wherein the single-wheel steering comprises:
a worm gear having a worm wheel, the worm wheel rotationally fixed to the steering knuckle and arranged coaxially with the pivot axis, and
a worm meshed with the worm wheel, wherein the worm wheel is rotatable about the pivot axis by operation of the worm wheel, and wherein the worm is configured to be driven by a steering motor arranged on the vehicle.

9. The wheel suspension device of claim 8, wherein the worm is connected to the steering motor by a steering drive shaft.

10. The wheel suspension device of claim 9, wherein the steering drive shaft is an articulated shaft.

11. The wheel suspension device of claim 8, wherein the worm wheel is a worm wheel segment.

12. The wheel suspension device of claim 11, wherein the worm wheel segment extends over a circumferential range between 180° and 270°.

13. The wheel suspension device of claim 8, wherein the steered vehicle wheel is coupled to a drive, wherein the drive is a wheel drive shaft including an articulated shaft, and
a double bevel gear train is operatively arranged between the wheel drive shaft and a driven wheel axle shaft of the vehicle wheel.

14. The wheel suspension device of claim 13, wherein the double bevel gear train comprises:
an upper bevel gear, and
a lower bevel gear rotationally fixed to the upper bevel gear, both the upper and lower bevel gears rotatably supported on the steering knuckle coaxially with the pivot axis,
wherein the upper bevel gear is meshed with an inner bevel gear rotationally fixed to the wheel drive shaft, and
the lower bevel gear is meshed with an outer bevel gear rotationally fixed to the driven wheel axle shaft,
wherein a drive torque from the wheel drive shaft is transmitted via the inner bevel gear to the upper bevel gear and from the upper bevel gear to the lower bevel gear and from the lower bevel gear to the outer bevel gear and the wheel axle shaft.

15. The wheel suspension device of claim 13, wherein the bevel gear train and the worm are arranged in a housing, which is non-pivoting relative to the pivot axis and is spring-suspended with the steering knuckle in the direction of the pivot axis.

16. The wheel suspension device of claim 15, wherein the housing is articulated on the vehicle chassis by means of a transverse link.

17. The wheel suspension device of claim 16, wherein the transverse link is attached to an underside of the housing.
